(19) United States
(12) Patent Application Publication
(10) Pub. No.: US 2003/0163444 A1
(43) Pub. Date: Aug. 28, 2003

(54) Method to optimize information downloading

(76) Inventor: Michael Kotzin, Buffalo Grove, IL (US)

Correspondence Address: MOTOROLA INC, 600 NORTH US HIGHWAY 45, LIBERTYVILLE, IL, 60048-5343, US

(21) Appl. No.: 10/083,893

(22) Filed: Feb. 27, 2002

(51) Int. Cl. G06F 7/00

(52) U.S. Cl. 707/1

(57) ABSTRACT

A method for reducing the perceived download time of a web page. This method comprises the steps of downloading a first web page (302) that contains hyperlinks (104) to other web pages. The web page or pages corresponding to the hyperlinks contained in the first web page are automatically downloaded (310) to the memory of the device prior to any intentional selection of the link (312). This selection may be by the user or by the software configured by the user. When the user does select the at least one hyperlink, the web page corresponding to said at least one hyperlink is displayed from the memory (314) in the device as opposed to first downloading the web page to the device's memory and then displaying. This is most important as wireless devices are adapted to receive web pages as initial download time of the representative data may be substantial. Billing for the use of web pages or data is based upon the display of the web page or data, as opposed to the downloading of the data. When a web page is displayed, a display acknowledgement is generated (318) and then relayed or communicated to the respective billing service.

### BACKGROUND OF THE INVENTION

This invention relates to an improved downloading and display method for internet browsing and more particularly to a method for improving the user experience by decreasing the delay between data downloads.

Wireless communication devices and more particularly handheld wireless communication devices that incorporate internet access capability are currently limited in the amount of data that can be downloaded as a result of bandwidth and system limitations. Current 2G system are the most limited while 2.5 and 3G systems progressively increase capacity as bandwidth and modulation technology improve data rates. Furthermore, channel loading can be quite irregular, having periods of intense use by multiple users intermingled with periods of little use.

As a result, current wireless internet access devices can display limited amounts of data and are prone to delay when a user makes a real-time requests. Devices that display web pages require large amounts of data and even more as the device displays color web pages. With current bandwidth limitations, the amount of data, whether color is supplied, and the instantaneous system loading will determine the amount of time necessary to download the data over the wireless interface to the device. The longer the information takes to download to the device, the longer it will take to display and the user's perception or experience degrades as one has to wait longer and longer for the information.

For example, a user may have a web page displayed on the device, which has hyperlinks contained within the page and within the text of the page are used to allow the user to navigate to other web pages or data. While viewing one web page, the user on the wireless device selects one of the hyperlinks and must wait as the information corresponding to that link is transmitted on the downlink to the device to be displayed. The user is satisfied if the information appears almost instantly. However, the user experience degrades as the time increases to complete the download and display the info on the screen. More data is even further required for color pictures, video, and audio.

Even as bandwidth increases though, and the technology migrates to third generation (3G) cellular systems, the service operator is interested in increasing capacity to generate more revenue from more users. It is desired to increase the perceived delivered information to an individual user.

One solution is to increase the system capacity directly to increase the user capacity of the system. As one skilled in the art understands, capacity is limited by the amount of available spectrum licensed and additional spectrum is either very costly to produce or simply unavailable.

Therefore there is a need to decrease the time an individual must wait from the time the user selects the link information, to the time the information is displayed on the device.

The various aspects, features and advantages of the present invention will become more fully apparent to those having ordinary skill in the art upon careful consideration of the following Detailed Description of the Invention with the accompanying drawings described below.

### BRIEF DESCRIPTION OF THE DRAWINGS

FIG. 1 is exemplary of a web page with hyperlinks;

FIG. 2 is exemplary block diagram of the device circuitry;

FIG. 3 is an exemplary process flow diagram of the invention;

FIG. 4 is an exemplary process flow diagram of the invention;

FIG. 5 is an exemplary predefined download list data file of the invention;

FIG. 6 is an exemplary predefined download list data file hierarchy of the invention; and

FIG. 7 is an exemplary process flow diagram of the invention.

### DETAILED DESCRIPTION OF THE PREFERRED EMBODIMENTS

The present invention is directed to the downloading of data and more particularly the downloading of web pages while web browsing.

The invention is a method for decreasing the time to display a web page while “browsing” or “surfing” from web page to web page using hyperlinks contained within the web pages being browsed. It is understood by one skilled in the art that hyperlinks are one means for pointing to or selecting a data source to transfer or download the desired data and one example of data is a web page. Other data may include pictures (in one of many compression formats) video, streaming or complete transfer, audio, and the like.

Although this invention is particularly applicable to wireless internet devices it may just as equally be applied to wired network devices that experience long delays in downloading data due to numerous circumstances such as net congestion or variable loading, or a poor communication link or the like. A wireless communication device such as a handheld radiotelephone or smart phone that has internet access capability may often have a slower data rate than conventional wired internet access. This is due to the variable characteristics of the over-the-air interface, the nature of current modulation schemes (including CDMA, GSM, TDMA, GPRS/EDGE, UMTS) and the capacity of the service provider driven by allotted spectrum and the number of active subscribers within a given timeframe and location. However, this invention is equally as useful when a user has a communication link that is simply low in throughput.

The method begins with the device downloading a first web page or data set to a first memory location of the device. The first web page contains at least one hyperlink that corresponds to a second web page or data set. The first web page is outputted or displayed to the user. While the user is viewing or using the data in its characteristic fashion (which may be audio, or some other output), the device is downloading the second web page or data set to a second memory location of the device. The downloading or transfer of the second web page may also occur at the same time that the first web page is being downloaded or while the first page is being written to the display. This might be particularly desirable to load a linked web page after the display has been rendered, if the user is likely to navigate to the hyperlink, i.e. the second web page, rather than scrolling to the remainder of the first web page. This can occur even prior to the loading of the entire first page. For example, a user may only read a certain portion of a web page, without reading the remainder. Only the portion of data that corresponds to the portion of the web page that the user reads needs to be downloaded. Instead of loading the remainder of the data that the user does not read, other data can be downloaded such as the links to other pages that the user commonly selects. In either case, the transfer of data for the second page occurs prior to selection of the corresponding hyperlink by the user. This is generally referred to as downloading in the background.

The user views the first web page, or at least a part thereof, and determines whether or not to, read on or select any other hyperlinks contained in the first web page. The user may now select the at least one hyperlink corresponding to the second web page (which may be already stored in the devices memory). Once selected, the device retrieves the data from the device memory (an alternative or second memory location of the device) and the device displays the second web page in response to said at least one hyperlink being selected. The initial trigger does not need to be a web page. It may be that the user opens a specific application on the device and this triggers the back ground downloading. It may also be triggered based on time or a scheduled event.

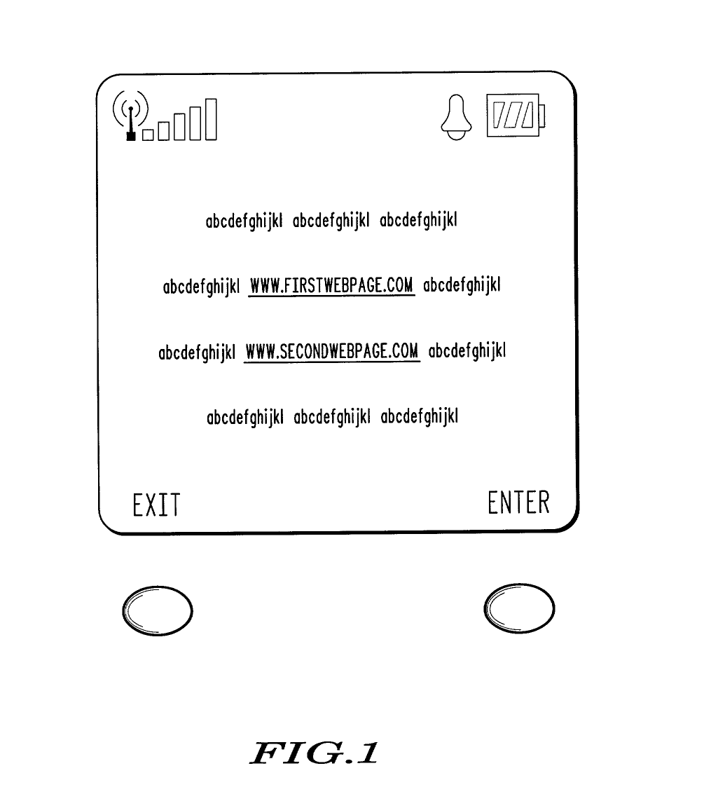

FIG. 1 illustrates a web page having at least one hyperlink 104. The hyperlink corresponds to another or second web page. This web page may either be a front page, “deep-linked” further into the first web page. The link may also link to another portion or section of the same web page (which for the purposes of the present invention may be logically thought of as the second web page). The natural interaction with web browsing and data retrieval commonly employs moving from web page to web page or from data set to data set. This is accomplished by selecting links or hyperlinks contained in the web page or data set. It is common for web pages to have at least one link 104 contained in the web page and even more common to have a plurality of links 106, 108, 110 contained within the web page. The links correspond to a desired set of data or another web page or different portions of the current web page. As shown in FIG. 1, this is an example of a web page on a wireless communication device.

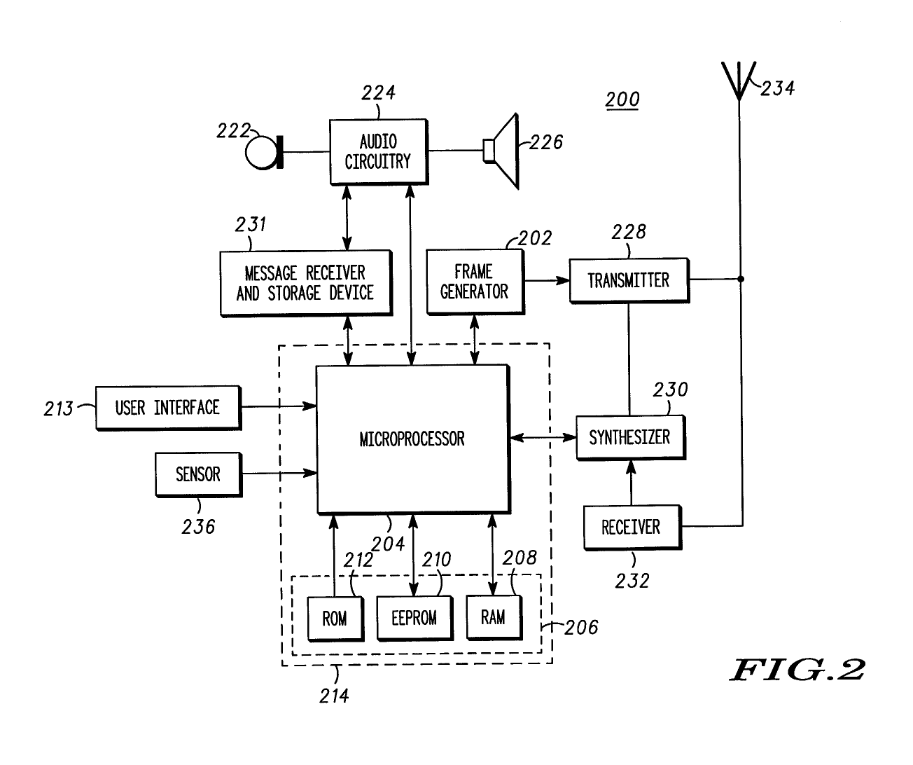

Turning to FIG. 2, a block diagram of a wireless communication device in accordance with the present invention is shown. This device is a wireless communication device such as a cellular radiotelephone incorporating the present invention. In the wireless communication device a frame generator ASIC 202, such as a CMOS ASIC available from Motorola, Inc. and a microprocessor 204, such as a 68HCp11 microprocessor also available from Motorola, Inc., combine to generate the necessary communication protocol for operating in the device. Microprocessor 204 uses memory 206 comprising RAM 208, EEPROM 210, and ROM 212, preferably consolidated in one package 214, to execute the steps necessary to generate the protocol and to perform other functions for the wireless communication device, such as reading or writing to a user interface 213 (display, keyboard, keypad, mouse etc . . . ) or controlling a frequency synthesizer 230 and controlling which web page is displayed on the user interface 213 and the download sequence thereof in accordance with the present invention. ASIC 202 processes audio transformed by audio circuitry 246 from a microphone 222 and to a speaker 226. The consolidated memory package 214 is where the data or web pages are stored as the information is transferred from the source, over-the-air, and later retrieved from memory 206 to display on the device's display if desired.

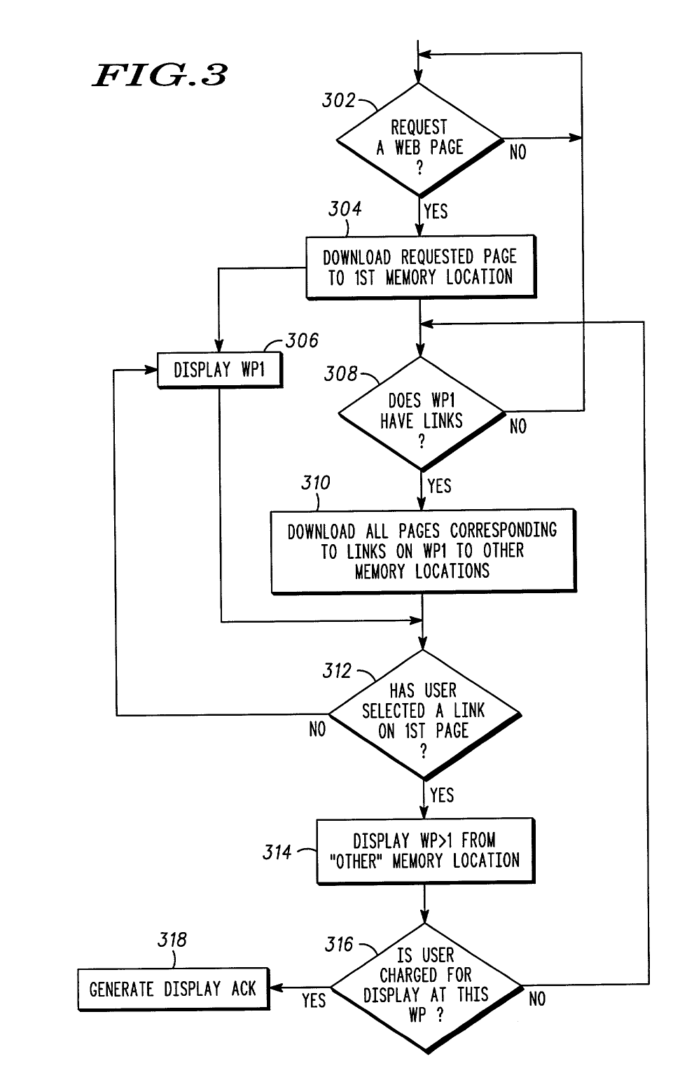

FIG. 3 is a flow chart illustrating the inventive process beginning with the downloading of the first web page to the device 302. Typically, this is initiated by the user selecting a hyperlink or perhaps choosing the web page from a list of “favorites” or previously selected pages. The user may also enter the web page by typing in the url or data identifier, entering with another text entry method or in some cases via a voice recognition system. Regardless of the method of selecting the first web page, the information is requested, received, and stored in a memory location 304 of the device. The information is then displayed 306 on the device in a typical web page fashion, formatted for the device, or outputted to the user in an output fashion consistent with the type of data. Besides a web page, this may be an audio file, such as a ring tone that is played through a speaker or a video, watched on the device display.

In one instance, as shown in FIG. 3, the device may automatically download other web pages or other data that correspond to links contained in the first web page at the same time the first web page is downloaded 310. Any other web pages that might have been downloaded are not displayed however until requested 312 by the user clicking on the hyperlink or some other means of selection such as a time attribute or a set of given conditions are met. While only the first web page is displayed 306, the other web pages, which may be requested and/or autonomously provided, are store in the devices memory 310. If and when the user selects a link contained in the first web page 312, and the corresponding web page has been fully or partially downloaded, the web page, or part thereof, corresponding to the selected link will be retrieved from the device's memory as opposed to being downloaded from the source 314. The time to display the second web page from the device memory is significantly shorter then the over-the-air download process. This gives the user a better experience as there is less delay between link selection and web page display or data output. The time between the selection of a link on the first page to the time the second web page is displayed, is therefore significantly reduced.

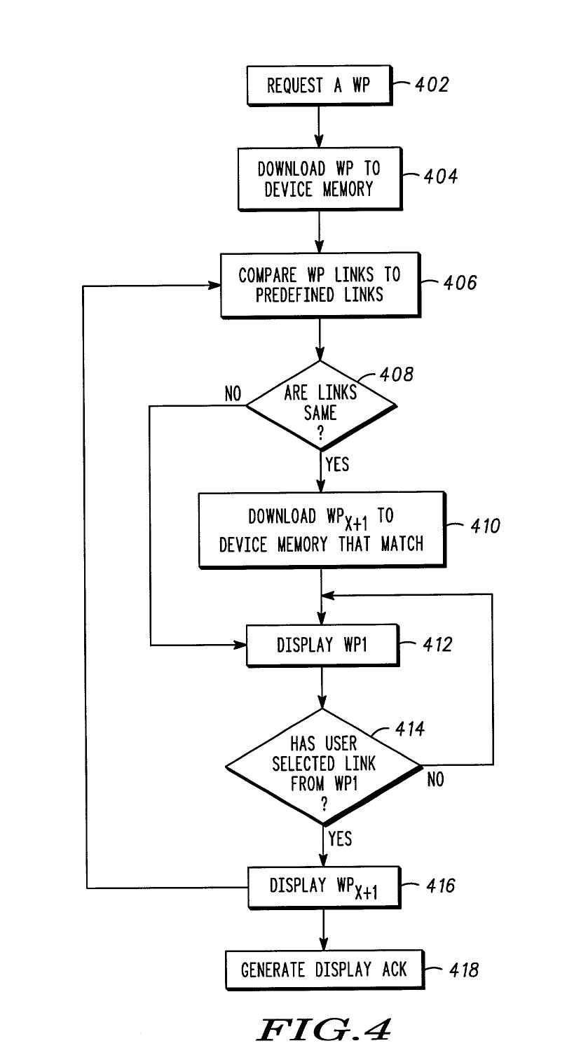

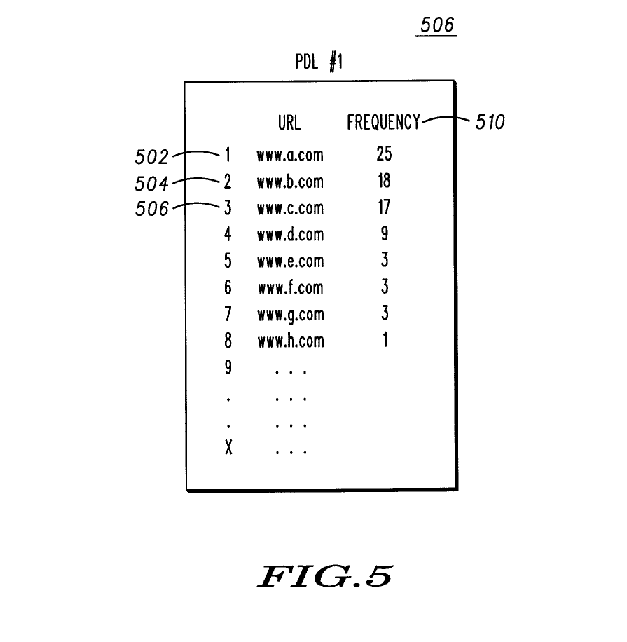

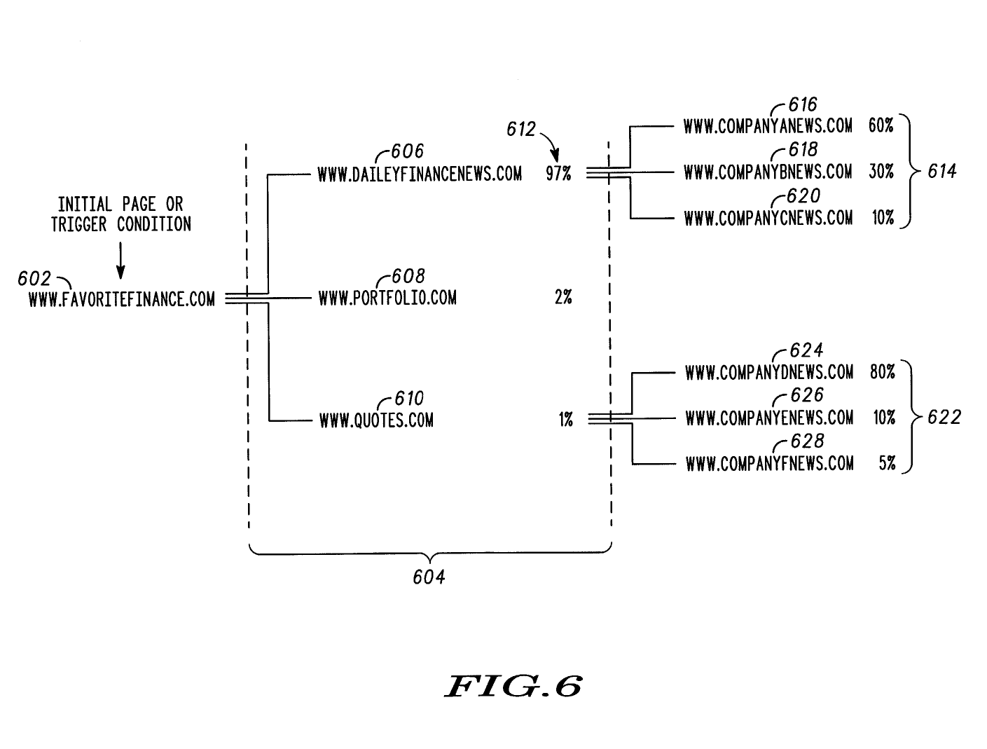

The method shown in FIG. 4 incorporates a predefined download list of web pages shown in FIG. 5 and FIG. 6. In FIG. 5, a first embodiment of the predefined download list (PDL) 500 is shown. This allows the device to track a user's link selection and “learn” browsing habits. In one instance, the user can define how the device learns user's browsing habits by selecting the type of behaviors (i.e. links to add to the PDL 500) the user wants the device to remember, in particular when to add hyperlinks to the PDL. For example, the user may wish to add to the PDL every link that the user selects 502, 504, 506. Another option is that a PDL would have category information associated with a link. For example a category may be finance 602. Any web pages then that are categorized as finance, would be added to the PDL and downloaded in priority fashion. Even further, an algorithmic approach can be applied to the users selection habits. For example, the device may automatically track the number of times a user selects a given hyperlink. The links with the highest number of selections or hit rate, or frequency 510 would be added to the PDL. In this case, constant updating and reprioritizing of the PDL is possible. However, this optimization does not only apply to the present user or the user of a given device. Habits may be tracked for other users, to be applied to an individual user. The PDL 500 is shown as a flat file or a single list of hyperlinks. This is advantageous when stored on the mobile device as it will require in general less memory and will generally only apply to the individual users habits.

However, when tracking more and more info from individual users as well as other users habits that are to be applied to the specific user, it is currently more feasible to do so remote from the subscriber device and instead within the infrastructure. Particularly, this scenario applies when tracking other users who have downloaded the same page, who may have also selected certain links or, some links may be more popular than others on a given web page. This information may be communicated between the infrastructure and the device so such data can be used to adapt the PDL. As mentioned before, requests for subsequent pages may be entirely controlled and managed by the infrastructure.

Illustrated in FIG. 6., the PDL may consist of a plurality of PDL's hierarchically linked together 600 either in a relational (or 3D) database that allows for increased prediction and tracking of what data is to be downloaded in the background to the users device. This may be one PDL that contains a hierarchically linked hyperlinks or several PDL's liked together to form a hierarchy of hyperlinks. FIG. 6 illustrates that a initial web page or trigger condition 602 has a set of related web pages represented by a first set of related, corresponding hyperlinks. The first set of related hyperlinks may be in a independent PDL or contained within one PDL that takes the form of a relational database containing a plurality of sets or related hyperlinks. The first set of related hyperlinks 604, comprises a at least a first link 602, a second link 608, and a third link 610, all related to the initial web page or trigger condition 602. It should be understood that three links is just an example and that many links may be related to the initial web page or trigger condition 602, but three are used for simplicity sake. The number of related links may depend on the relationship to the initial web page 602 or set by the user. The first link 606 is first on the first set of related hyperlinks 604 and will be the first to be downloaded in the background. In one instance, this link is first on the first set of related links 606 because the user always selects this link 606 subsequent to viewing the initial web page or 602. Another instance puts the first hyperlink 606 on the top of the list because a majority of other users who browse the initial web page, select the first link 606 first, before any other link. This priority can be measures by the number of hits or frequency of selection. The second link 608, has the second highest priority based on the two prioritization methods above. The third link 610 has the third highest priority. The web pages corresponding to the first, second, and third links are downloaded in the background in the order of priority.

The first link 606, will further point to a second set of related hyperlinks 612, in which the links are given a priority. The first link 614, of said second set of related links 612, having the highest priority within the second set of related links 612, will be downloaded in the background, following the download of web pages corresponding to the first set or related links 604. Alternatively the device may background download only the links with the highest priortity first, and then those which have the second highest priority and so on. The first link 614 of the second set of related links 612 may further point to a third set of related links and so on. To be specific, consider the example of when a user downloads his favorite finance web page. A user will generally choose certain links from within the finance web page 602 on a regular basis, such as the Daily Finance News link 606. Therefore the Daily Finance News link 606 would be contained in the first set of related links 604 and assigned the highest priority (based on statistics calculated by the user or other users). As a result, the corresponding web page would be downloaded in the background as the user reads the first page of his favorite finance page 602. When the user selects the Dailey Finance news link 606, the web page corresponding to the Dailey Finance news link 606 will have already been downloaded to the device and as a result will be displayed almost instantaneously )(only limited by the speed of the device processor and related circuits).

Similarly, there may be a link contained within the Dailey Finance News web page 606 that the user statistically selects first 614. Therefore, the Dailey Finance News web page 614, would have a second set of related links 612 associated therewith. This second set of related links 612 would have the list of links ranked in priority order, according to the selection algorithm. Each of these links in turn have a set of related links, or associated links, ranked based on their selection algorithm and so on.

The user has the option to determine a what point the downloading is terminated and the priority order of the background downloading. Alternatively, this can be determined by the device itself, based on usage or memory capacity and even further, the service provider may determine the background download activity based on spectrum, system capacity and loading.

Once the initial web page is downloaded to the device memory in step 404, the hyperlinks contained within and downloaded with the first web page are compared to the PDL 406. Next, the links in the PDL are compared to the links on the first web page 408. At the same time the first web page is displayed or outputted to the user interface 121. If a hyperlink contained in the first web page matches a hyperlink in the PDL , the web page corresponding to the hyperlink is also downloaded in the background to the devices memory 410 prior to selection by the user. A plurality of hyperlinks contained in the first web page may be indicated in a priority order in the PDL, and web pages are then sequentially downloaded to the device's memory 410. As the user selects links for web pages 414 that have been downloaded already to the device memory, these web pages are displayed 416 therefrom. Again, the time from user selection of the hyperlink to display is relatively short as compared to downloading over the air or in a congested network scenario. It is understood that background downloading may be done in a low priority fashion so that it does not disrupt any other users or the system. In this way, it is fully possible to exploit any excess system or channel capacity and level system usage. It is also understood that only downloaded pages may be held in memory on the chance that they might be needed in the near future.

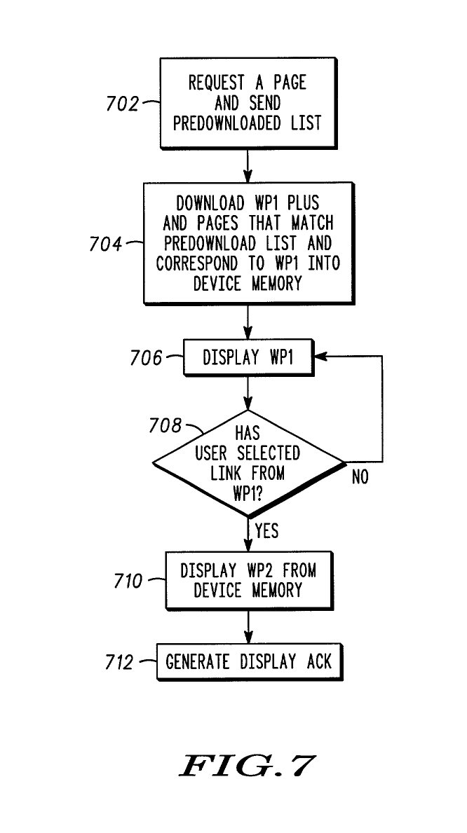

Moving to FIG. 7, the method for downloading begins by sending a request to download the initial web page and transferred along with that request is the PDL 702. In response, the system will transmit the initially requested web page, and in the background will convey any additional web pages contained with the first web page 704 and that match the predefined list in the predefined order. The initial web page is automatically output to the user 706 upon partial or complete reception. Subsequently, if the user selects a hyperlink 708 that is contained in the first web page, that was also on the PDL, and has already been downloaded, the device will retrieve the second web page from the device memory for output 710 as above. Here the PDL is sent from the device and the comparison of links is performed remotely. Upon the user's request to navigate to the second web page, an exchange of information will ensue between the device and the infrastructure or another device, so that a new PDL is conveyed.

Any web pages that are not on the PDL will not be stored in the device memory and will have to be retrieved from the source when the user selects the hyperlink. The device will then have the option of adding the hyperlink to the PDL for future downloads. The user may also set limits to the background downloading such as file size or file or web page category. File size may limit the size of web pages downloaded to less than 50k for example.

If information that is downloaded to the device has a tariff or charge associated therewith, the owner of the information will need to receive notice that the information has been downloaded to a certain device. In the case of the present invention the user may not always display or use the information or web page even though it was downloaded to the device. Therefore, a display receipt or display acknowledgement 318, 418, and 712 will be generated and sent back to the owner when the information is actually outputted to the user in some form as described above. If the information is preloaded, through background transfer into the devices memory but never requested by the user, the receipt is not sent and the user is not charged. The device may also request as shown in FIG. 3 if the web page is a tariff web page or not 316. Then proceed to step 318.

Alternatively, a charge may be due by the service provider just for carrying the information. Similarly, only if the user requests a page, is the appropriate charge made for use of the channel resources. Communication of such information is continuously exchanged between the device and the infrastructure, hosting device or network entity.

While the present inventions and what is considered presently to be the best modes thereof have been described in a manner that establishes possession thereof by the inventors and that enables those of ordinary skill in the art to make and use the inventions, it will be understood and appreciated that there are many equivalents to the exemplary embodiments disclosed herein and that myriad modifications and variations may be made thereto without departing from the scope and spirit of the inventions, which are to be limited not by the exemplary embodiments but by the appended claims.

What is claimed is:

1. A method for decreasing the time to display a web page on a device comprising:
receiving a first web page to a first memory location of said device, said first web page having at least one hyperlink that corresponds to a second web page;
displaying at least a portion of said first web page on said device from said first memory location on a display of said device; and
downloading in the background said second web page to a second memory location of said device.

2. The method of claim 1, comprising selecting at least one hyperlink from said first web page, said at least one hyperlink corresponding to said second web page.

3. The method of claim 2 comprising displaying said second web page on a display of said device from said second memory location of said device in response to said at least one hyperlink being selected.

4. The method of claim 3 comprising generating a display acknowledgement in response to displaying said second web page.

5. The method of claim 2 comprising selecting said at least one hyperlink by the point and click method.

6. The method of claim 2 comprising selecting said at least one hyperlink by the meta tag method.

7. The method of claim 1 comprising prior to downloading said first web page, predefining a download list of web pages having at least one hyper link and
searching said first web page for said at least one hyper link.

8. The method of claim 7 comprising downloading to said second memory only those web pages of said predefined download list.

9. The method of claim 7 wherein the user predefines said download list.

10. The method of claim 7 wherein said predefined download list contains hyperlinks that have a greatest frequency of hyperlink selection.

11. The method of claim 10 wherein said greatest frequency of hyperlink selection is based on the users hyperlink selection history.

12. The method of claim 10 wherein said greatest frequency of hyperlink selection is based on other users hyperlink selection history.

13. The method of claim 1 wherein said device is a wireless communication device.

14. The method of claim 3 comprising generating a display acknowledgement message in response to displaying said second web page on a display of said device.

15. The method of claim 1 wherein said second web page is a portion of said first web page which is not said at least a portion of said first web page.

16. A method for reducing the perceived download time of a web page in a wireless communication device comprising:
downloading a first web page to a first memory location of said wireless communication device, said first web page having a plurality of hyperlinks corresponding respectively to a plurality of web pages;
outputting said first web page from said wireless communication device;
downloading a plurality of web pages, said web pages corresponding to said plurality of hyperlinks of said first web page, to a second memory location of said wireless communication device, prior to selection of at least one hyperlink of said plurality of hyperlinks.

17. The method of claim 16, comprising selecting at least one hyperlink from said plurality of hyperlinks of said first web page.

18. The method of claim 17 comprising displaying a second web page, said second web page corresponding to said at least one hyper link of said first web page.

19. The method of claim 18 comprising prior to the step of downloading said plurality of web pages, comparing a said plurality of hyperlinks of said first web page to a predefined download list comprising hyperlinks.

20. The method of claim 18 comprising downloading only said web pages that match said predefined download list.

21. A method for downloading a web page to a wireless device comprising:
displaying a first web page on said device, said web page having at least one hyperlink;
downloading a second web page, said second web page corresponding to said at least one hyperlink of said first web page, to a memory location of said device;
selecting said at least one hyperlink of said first web page.

22. The method of claim 21 outputting said second web page from said memory location of said device in response to said selecting said at least one hyperlink of said first web page.

23. The method of claim 22 wherein said outputting said second web page is displaying said web page on a display of said device.
